(19) United States
(12) Patent Application Publication
(10) Pub. No.: US 2010/0029291 A1
(43) Pub. Date: Feb. 4, 2010

(54) Method for the time-based control of an upward signal transmission in a radio communication system

(76) Inventors: Iwajlo Angelow, Wroclaw (PL); Mieszko Chmiel, Glucholazy (PL)

Correspondence Address: STAAS & HALSEY LLP, SUITE 700, 1201 NEW YORK AVENUE, N.W., WASHINGTON, DC, 20005, US

(21) Appl. No.: 12/311,603

(22) PCT Filed: Oct. 1, 2007
(86) PCT No.: PCT/EP2007/060410

§ 371 Date: Apr. 6, 2009

(30) Foreign Application Priority Data
Oct. 4, 2006 (EP) 06460034.9
Oct. 24, 2006 (EP) 06022237.9

(51) Int. Cl. H04W 56/00

(52) U.S. Cl. 455/450

(57) ABSTRACT

A method controls a time-based transmission of signals of a subscriber terminal for synchronous reception at a base station of a radio communication system. Upon detection that a determined time offset of received signals is equal to or greater than a predetermined threshold value, a change from one-step control commands to multi-step control commands for controlling the time-based transmission of the subscriber terminal is performed by the base station, or a synchronization procedure is initiated by means of a randomly chosen access channel by the subscriber terminal.

### CROSS REFERENCE TO RELATED APPLICATIONS

This application is based on and hereby claims priority to PCT Application No. PCT/EP2007/060410 filed on Oct. 1, 2007, EP Application No. EP06022237 filed on Oct. 24, 2006 and EP Application No. EP06460034 filed on Oct. 4, 2006, the contents of which are hereby incorporated by reference.

### BACKGROUND OF THE INVENTION

The invention relates to a method for the time-based control of an upward signal transmission by subscriber terminals in such a manner that these can be received synchronously at the location of a base station of a radio communication system.

Current radio communication systems and those being standardized have different needs for synchronizing transmissions in the upward direction by subscriber terminals so that these can be received and processed synchronously or at least within a tolerable time band by a base station, and use different approaches for this purpose.

Thus, for example, a so-called multi-step timing alignment control (TAC) is used both with a first access of a subscriber terminal and in existing connections in accordance with the familiar GSM (global system for mobile communication) standard. In the case of a random initial access, the subscriber terminal initially orientates itself on signals of the base station transmitted in the downward direction for controlling the time-based transmission of an access radio block in accordance with the principle of an open loop. The access radio block exhibits a comparatively large guard period in order to increase the probability of a reception of the access radio block within a time window or time slot by the base station. After the access radio block has been received by the base station, it signals, in dependence on the time of reception of the access radio block, to the subscriber terminal whether a retarding or advancing, i.e. adjusting of the so-called timing advance, of the transmission by the subscriber terminal is required. In this arrangement, the base station uses the multi-step signaling to inform the subscriber terminal by what number of time units such a retarding or advancing should take place. In the case of existing connections, for example a so-called circuit-switched connection, the base station orientates itself in accordance with the principle of a closed loop on voice data packets transmitted by the subscriber terminal in the connection or on signals of the so-called SACCH (slow associated control channel). During interruptions of the voice data transmission, i.e. for example, during a so-called DTX (discontinuous transmission) period, the controller of the timing advance, in contrast, orientates itself on so-called SID (silence description) frames sent periodically by the subscriber terminal or on signals of the SACCH so that a time-based adaptation of the transmission takes place every four multiframes or 480 ms, respectively, in every case.

In the case of a packet-oriented connection according to the GPRS (general packet radio system) standard, a time-based adaptation of the transmission also takes place every 480 ms, the base station orientating itself on received data packets. In the case where the subscriber terminal does not send out any data packets over a relatively long period or no radio resources are assigned to it in the upward direction, the controller orientates itself on access radio blocks sent every eight multiframes or 960 ms, respectively, by the subscriber terminal.

In contrast to the GSM and GPRS standards described above, the FDD (frequency division duplex) mode of the UMTS (universal mobile telecommunication system) standard, also called W-CDMA (wideband code division multiple access) does not have any control of the transmissions in the upward direction, neither as part of an initial access nor in existing connections. Transmissions in the upward direction only orientate themselves on the time of the reception of signals in the downward direction so that signals from subscriber terminals which are located at different distances from a base station are not received synchronously in time by the base station.

For the development of the UMTS standard standardized within the framework of the 3GPP (3rd generation partnership project) and referred to as Evolved Universal Terrestrial Radio Access (E-UTRA) or LTE (long term evolution), it is currently provided, according to Chapter 9.1.2.6 of the current technical report 3GPP TR 25.814 V7.0.0 (2006-06) “Physical layer aspects for evolved universal terrestrial radio access (UTRA) (Release 7)”, that the base station (eNB—E-UTRAN NodeB) signals so-called timing control commands for controlling the time-based transmissions of the subscriber terminals (UE—user equipment). In this context, two alternative embodiments of these commands are considered: on the one hand, a so-called binary timing control command which, by two binary states of a signaling bit, controls a retarding or advancing of the transmission by a certain step width, still to be defined, in microseconds (μs) and is signaled with a periodicity which is also still to be defined; on the other hand, a command which more or less corresponds to the multi-step timing alignment control command of the GSM standard which, however, is only signaled in dependence on requirement.

The use of binary timing control commands doubtlessly offers the advantage of an only slight signaling load by using only a single signaling bit, wherein, in supplementary fashion, the network must predetermine a definition of the step width and of the periodicity, if necessary on a higher protocol layer, and signal it to the subscriber terminal, which, in turn, can occur in dependence on the situation or also periodically. Disadvantageously, however, a command can only be used for realizing a particular change in the time-based transmission which can lead to the control system not being able to follow these changes in a sufficiently rapid manner, in particular in the case of a rapidly changing multi-path transmission occurring at the radio interface. Reference is made in this respect to the so-called birth-dead example of Attachment B.4 of the Technical Specification TS 25.104 V7.4.0 (2006.06) “Base Station (BS) radio transmission and reception (FDD) (Release 7)”, according to which a path can experience a relative change of up to 9 μs within a period of 191 ms.

By using multi-step timing control commands, in contrast to binary timing control commands, it is possible to respond relatively efficiently and flexibly to rapid path changes but this disadvantageously leads to a distinctly increased signaling load compared with binary information.

### SUMMARY

It is one possible object, therefore, to specify a method and components of a radio communication system which provide for flexible and at the same time efficient timing control of signal transmissions in the upward direction.

The inventors propose that, for controlling a time-based transmission of signals of a subscriber terminal for a synchronous reception at a base station of a radio communication system, upon detection that a determined time offset of received signals is equal to or greater than a predetermined threshold value, a change from one-step control commands to multi-step control commands for controlling the time-based transmission of the subscriber terminal is performed by the base station, or a synchronization procedure is initiated by a randomly controlled access channel by the subscriber terminal.

Advantageously, this makes it possible, when necessary, i.e. in the case of a comparatively large time offset occurring, to change flexibly from initially described binary control commands to multi-step control commands in order to achieve by this means a rapid restoration of synchronism. The alternative performance of a synchronization procedure, for example by the randomly controlled access channel, has the advantage that instead of a lengthy restoration of synchronism by timing control commands, known mechanisms are used for achieving the synchronism and in this manner, the entire signaling load at the radio interface is reduced.

According to a first embodiment, a binary or ternary signaling bit is used as one-step control command. Using a ternary signaling bit instead of a known binary signaling bit is also an alternative. It advantageously enables a third state or command, for example that there should be no time-based changes of transmissions by the subscriber terminal, to be signaled and thus to prevent time-based adaptations which are actually not required and which lead to an increased energy consumption of the subscriber terminal.

According to a further embodiment, the time offset forming the basis of the comparison with a threshold value is determined by the base station and/or the subscriber terminal, the time offset, according to a further embodiment, being determined by comparing a time of reception of received signals with a timing reference. In this way it is possible to control on the basis of determinations and decisions by the base station or the subscriber terminal whether there should be a change of the format of the timing control commands or a synchronization procedure.

According to a further embodiment, a current status of the subscriber terminal and/or a service type of an existing connection to the subscriber terminal is taken into consideration in the decision whether a change of the control commands is to be carried out or a synchronization procedure is to be initiated. If, for example, a service with high quality of service (QoS) requirements is involved, it may no longer be possible to meet predetermined requirements when carrying out a synchronization procedure. In this case, compensation for the determined time offset, and thus meeting the requirements, is only possible by changing to multi-step timing control commands. The situation is different in the case of a service having only low requirements with respect to time delays. In this case, a synchronization procedure can be advantageously run without the given requirements not being met. The same applies, for example, to the status of a subscriber terminal, i.e. for example, whether it is actively maintaining a connection or is only passive or sleeping.

A radio communication system and components of the system in the form of a base station and a subscriber terminal in each case have components for carrying out the method.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows an exemplary structure of a radio communication system,

FIG. 2 shows timing diagrams for the exemplary representation of the timing drift of transmissions in the upward direction,

FIG. 3 shows timing diagrams for the exemplary representation of the time offset between signals of different subscriber terminals,

FIG. 4 shows a flowchart of a first method according to the proposal, and

FIG. 5 shows a flowchart of a second method according to the proposal.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

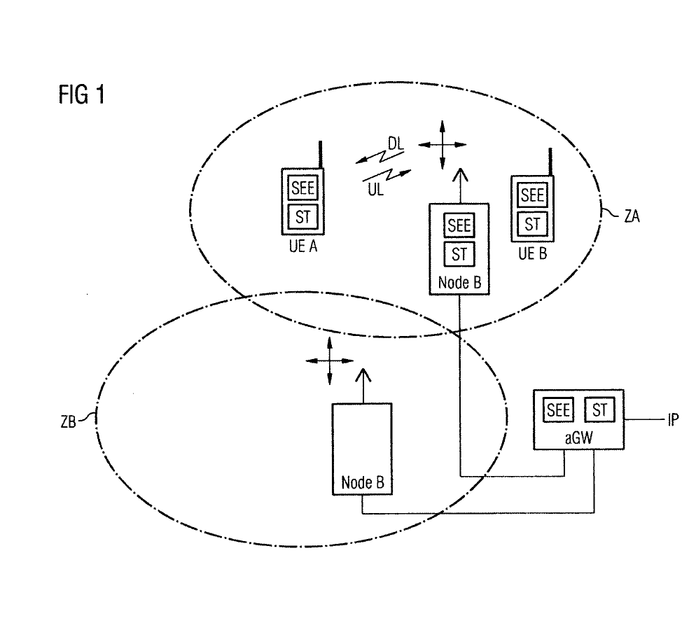

FIG. 1 shows, by way of an example, the structure of a radio communication system, especially in accordance with the current state of the E-UTRA and UMTS-LTE standardization. A so-called access gateway aGW is connected to other components of the system or other systems, respectively, via an IP-based (Internet Protocol) network. The access gateway aGW exchanges data traffic in the form of data packets with this network. The access gateway aGW is also connected to a multiplicity of base stations Node B which in each case supply an exemplary radio cell ZA or ZB with radio resources. The base stations Node B shown by way of example are in turn connected to subscriber terminals UE A, UE B via a radio interface. At the radio interface, signals are transmitted in the upward direction UL (uplink) and downward direction DL (downlink). The components of the radio communication system involved in the proposed method in each case have at least one transmitting/receiving device SEE for transmitting and receiving signals and a controller ST for controlling the component and the behavior of the transmitting/receiving devices SEE.

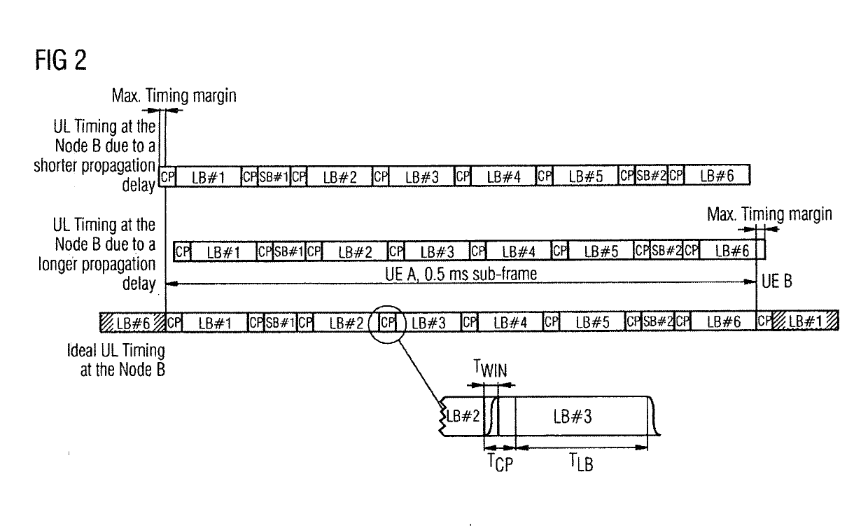

FIG. 2 shows timing diagrams for the exemplary representation of the timing drift of signals sent in the upward direction UL by the subscriber terminal UE in dependence on a change of propagation delays. In this context, FIG. 2 is taken from the technical document Tdoc R1-062372 having the title “Considerations on E-UTRA Uplink Time Synchronization”, which was introduced during the 3GPP TSG-RAN WG1 #46 conference in Tallinn, Estonia, Aug. 28 to Sep. 1, 2006, to which reference is made for further explanations. In the bottom timing diagram, a maximum time offset (max. timing margin) supported at the receiver end is defined by way of example on the basis of an ideal time (ideal UL timing at the Node B) for the reception of signals, sent in the upward direction UL in a subframe, at the location of the base station Node B. The two upper timing diagrams show a reception, which is premature in time in comparison with this ideal time, of signals of a subframe beginning with a so-called CP (cyclic prefix) field, due to a shorter propagation delay, and a reception of signals of a subframe, late in time due to a longer propagation delay, which are each case to be compensated for by the timing control.

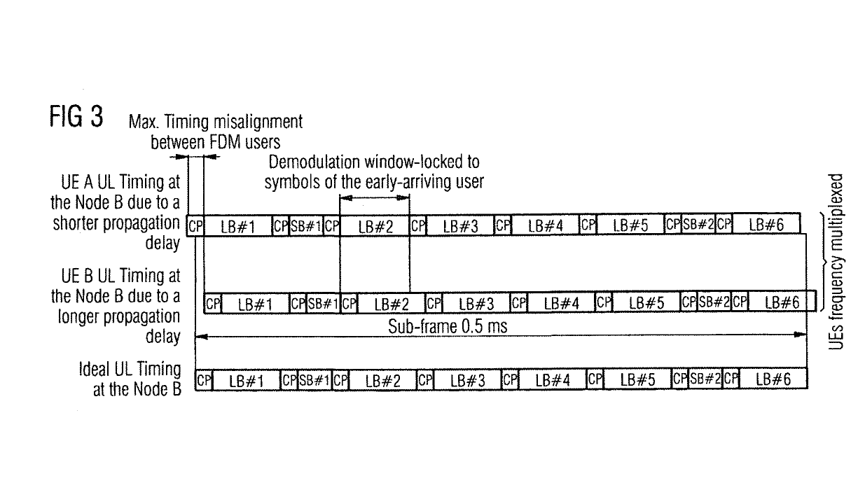

FIG. 3 shows corresponding timing diagrams for subscriber terminals UE A, UE B, in each case using a different frequency (UEs frequency multiplexed), as are shown by way of example in FIG. 1. Due to a different physical distance from the base station Node B, signals of a respective subframe arrive at different times at the location of the receiving base station Node B. In order to ensure in such an exemplary case a simultaneous demodulation of signals, for example of the data block LB#2, of both subscriber terminals UE A, UE B within a timing window (demodulation window), a maximum time offset (maximum timing misalignment) should not be exceeded.

According to the current state of E-UTRA standardization, see Tdoc R1-062372, the maximum time offset should be less than the length, preferably less than half the length, of a cyclic prefix which is assumed to be ˜3.65 to 4.13 μs. In this context, values within the range of 0.5 to 1 μs are conceivable, wherein, according to the example of FIG. 3, the maximum time offset should be selected to be less than half a length of the cyclic prefix, i.e. less than ˜2 μs. However, this maximum value is already reached after 0.5 or 1 second, respectively, at an assumed maximum speed of a subscriber terminal of 500 km/h and a perpendicular direction of movement with respect to the base station. However, a maximum time offset dimensioned in such a manner from approx. 0.5 to 2 μs is not suitable for compensating for rapid changes of the propagation paths of up to 9 μs within 191 ms by binary timing control commands, the maximum step width and periodicity of the signaling of which is oriented on the maximum time offset, according to the birth-dead example of the technical specification TS 25.104 mentioned initially.

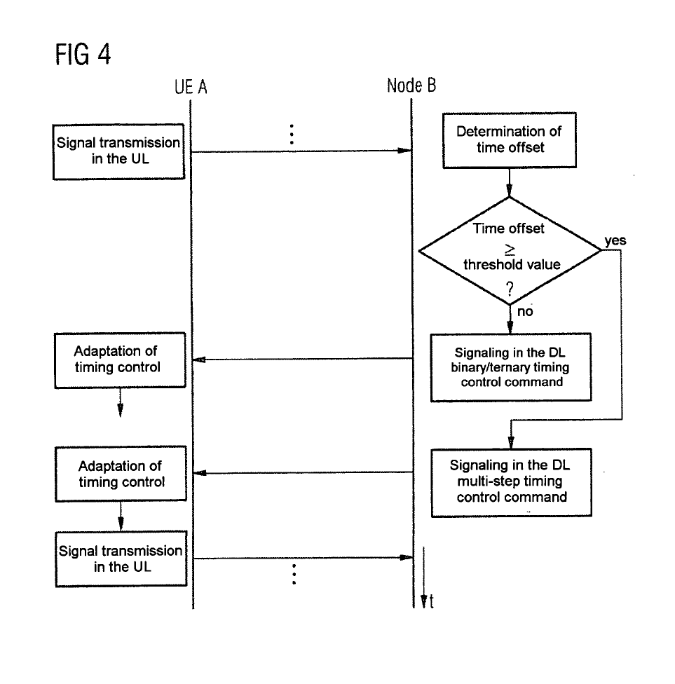

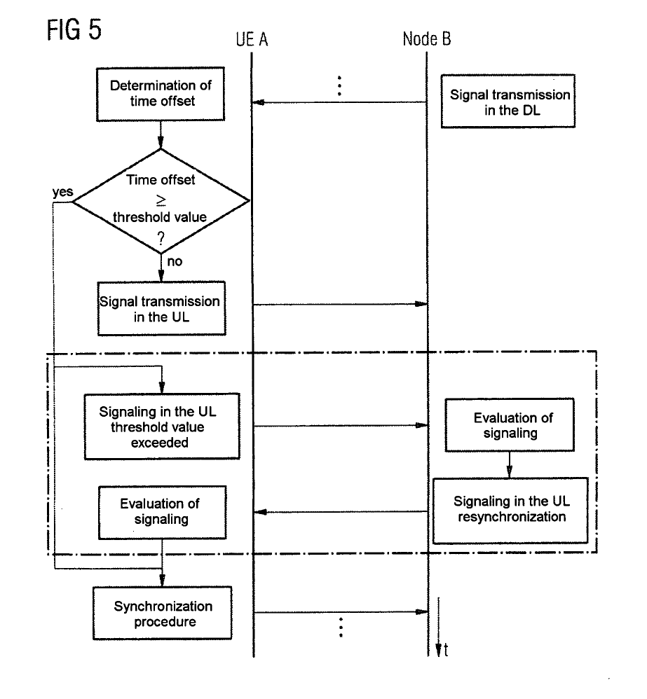

FIG. 4 and FIG. 5 then show a first and a second exemplary embodiment of the method, individual actions in the exemplary base station Node B and the subscriber terminal UE A of FIG. 1 and signal transmissions at the radio interface between these after time t being specified in the specified flowcharts. Naturally, apart from the actions shown, other actions and signaling transmissions are possible which, however, are of no significance to the description of the method.

As an initial situation it shall be assumed that the subscriber terminal UE A is in a so-called RRC Connected Mode, i.e. in a state of active signaling exchange with the base station Node B, among other things for maintaining time-based synchronization with the timing reference of the base station Node B. This means that during an active transmission of signals, for example of data packets of a service in a traffic channel or of special messages or sequences in a control channel, in the upward direction UL to the base station Node B, the latter determines a time offset of the received signals with respect to its own timing reference. During multi-path propagation at the radio interface, the base station Node B orientates itself, for example, on the strongest path of the received signal for determining the time offset. Depending on the determined time offset, i.e. whether and to what extent the received signals have arrived prematurely or late, the base station Node B signals in the downward direction DL to the subscriber terminal UE A that a transmission of subsequent data or signals in the upward direction UL should take place advanced or delayed by a certain time-based measure. If necessary, the base station Node B can do this in several signaling steps, for example when the subscriber terminal UE A is maintaining a packet data service and sends data and/or signaling messages to maintain synchronism in the upward direction UL to the base station Node B only at relatively long time intervals, for example every four multiframes, but the base station Node B signals a respective adaptation of the time-based transmission of the subscriber terminal UE A in every multiframe.

It is also assumed that the signaling of the base station Node B for the time-based control of the transmissions of the subscriber terminal UE A takes place on the basis of binary timing control commands as are known from the currently existing standards or on the basis of ternary timing control commands. This means that the subscriber terminal UE A is signaled, for example by a signaling bit having the value +1, to delay the transmission by 1 μs, whereas a value of −1 signals to advance the transmission by 1 μs. In the case of a ternary timing control command, the value 0 would signal, for example, that the subscriber terminal UE A should not perform any time-based change of the transmission. As already described above, the step width and the periodicity of the transmission of timing control commands can be dimensioned in dependence on the maximum time offset. In every case, however, it is necessary that the subscriber terminal UE A knows the periodicity and step width in order to be able to receive the commands and to implement them as desired by the base station. For this purpose for example, signaling is performed by the base station Node B in accordance with known protocols at higher layers.

In FIG. 4, a signal transmission of the subscriber terminal UE A takes place on the basis of the initial situation described above, at the radio interface in the upward direction UL to the base station Node B, in the radio cell ZA of which the subscriber terminal UE A is currently located in accordance with the example of FIG. 1. This signal transmission, for example a data packet of a data service or a synchronization sequence, is received by the base station Node B and, to determine a time offset, the detected strongest signal path, for example, is compared with a base station-internal timing reference. Following this, the base station Node B carries out a comparison of the determined time offset for the subscriber terminal UE A with a predetermined threshold value. If the comparison shows that the determined time offset is less than the threshold value—result “no”—, the base station Node B then furthermore carries out signaling of a binary or ternary timing control command which is taken into consideration by the subscriber terminal UE A receiving this command, for adapting the time-based control of subsequent transmissions. If, in contrast, the comparison shows that the determined time offset is equal to or greater than the predetermined threshold value—result “yes”—, the base station Node B changes from signaling by binary or ternary timing control commands to signaling of multi-step timing control commands.

Multi-step timing control commands have the advantages described above that a greater step width provides for a more rapid adaptation to the current time offset even without having to adapt a step width via higher level, and thus slow protocols, as would be required in the case of binary or ternary commands. Thus, resource-saving binary or ternary commands are used for the case of a time offset below the predetermined threshold value, which mainly occurs in practice, whereas more rapid and more flexible multi-step commands are used in the case of a determined time offset equal to or greater than the predetermined threshold value, which occurs less frequently.

If, for example, the threshold value is defined with 3 μs, this would enable the base station Node B to compensate for a time offset of 3 μs within three multiframes, i.e. before the subscriber terminal UE A carries out a subsequent signal transmission, by binary or ternary timing control commands, with a step width of 1 μs and a periodicity of one timing control command per multiframe. If, according to the method described above, for example, the time offset of signals of the subscriber terminal UE A were determined as 5 μs by the base station Node B, this would mean a transgression of the threshold value of 3 μs and the base station Node B would correspondingly change from the current binary or ternary command signaling to a signaling of multi-step commands for compensating for this time offset.

In order to be able to correspondingly implement these commands, the subscriber terminal UE A must recognize such a change in the format of the command signaling. This recognition can be done in different ways. Thus, for example, the change in command format or the transgression of the threshold value can be signaled explicitly to the subscriber terminal UE A, for example by setting a status bit of a signaling message on the physical or a higher layer of the ISO-OSI layer model. In this context, the status bits can be transmitted, for example, on the physical layer (layer 1) or data link layer (layer 2) in a common channel for several subscriber terminals.

As an alternative, the subscriber terminal UE A can also continuously attempt to receive or to detect multi-step commands, i.e. binary or ternary commands and multi-step commands can be distinguished with respect to their content by the subscriber terminal so that there does not need to be any explicit signaling of the change by the base station Node B in this case. If necessary, this can also be carried out only at periodic intervals by the subscriber terminal UE A, i.e. the subscriber terminal attempts, for example, every two frames to detect a multi-step command and thus notices a change in the command format carried out by the base station. The subscriber terminal similarly notices a change back to the binary or ternary command signaling. This advantageously limits the energy-consuming processing in the subscriber terminal UE A.

According to a further alternative, the subscriber terminal UE A can autonomously determine a change in the command format and correspondingly adapt the detection to this if it receives signals of the base station Node B with a large time offset, or one which is above a threshold value, with respect to previously received signals (comparable with the subsequent description for FIG. 5), and a time-based reciprocity is assumed even when different frequencies are used between transmissions in the upward direction UL and downward direction DL. For this purpose, the subscriber terminal UE A, for example, can also orientate itself on signals of a pilot channel, synchronization channel or broadcasting channel.

Furthermore, as an alternative to the above embodiments, the known signaling arrangements as used for the definition of the step width and periodicity of binary commands can also be changed or supplemented in such a manner that the subscriber terminal, at a particular value of the step width and/or the periodicity, is implicitly signaled that subsequently multi-step commands are used by the base station.

The steps, described above with respect to FIG. 4, are advantageous especially for subscriber terminals or connections for which a rapid response to timing drifts changing rapidly is required. These are subscriber terminals, for example in a so-called RRC connected active mode or in an RRC connected mode with a service sensitive to transmission delays such as, for example, video data transmission.

FIG. 5 shows a second exemplary embodiment of the method in the form of a flowchart which is again based on the initial situation described above. According to the present exemplary embodiment, the subscriber terminal UE A receives signals of the base station Node B, in the radio cell ZA of which it is currently located, and controls a time-based transmission in the upward direction to the base station Node B in accordance with the principle of an open control loop. These can be, for example, signals of a pilot channel, synchronization channel or broadcasting channel, which is transmitted by the base station Node B with a comparatively high transmitting power and provides the subscriber terminal UE A with reliable detection.

The received signals or the strongest signal path, respectively, are compared in the subscriber terminal UE A with previously received signals or their determined timing reference and a relative time offset between signals received previously and received currently is determined. Following this, the subscriber terminal UE A compares the determined time offset with a predetermined threshold value. In this context, this threshold value is defined, for example, by a standard specification or is signaled to the subscriber terminal UE A as an individually adaptable value by the base station B or a higher-level component of the system.

If the comparison shows that the determined time offset is less than the threshold value—result “no”—, the subscriber terminal UE A performs a time-based control of subsequent signal transmissions in the upward direction UL in accordance with the known method, if necessary by taking into consideration binary or ternary timing control commands received by the base station Node B.

If, in contrast, the comparison shows that the determined time offset is equal to or greater than the predetermined threshold value—result “yes”—, the subscriber terminal UE A initially does not send any further signals in the upward direction to the base station Node B but performs a new synchronization procedure. This resynchronization is appropriate since the probability of detection of signals subsequently transmitted in the upward direction UL is greatly reduced due to the great time offset.

If the subscriber terminal UE A carries out, for example, a so-called unsynchronized RACH (random access channel) procedure, i.e. the subscriber terminal UE A initially controls the time-based transmission in accordance with an open control loop exclusively by signals, received by the base station Node B, of a pilot, synchronization or broadcasting channel, and sends one or more access messages in a randomly controlled access channel RACH, the probability of detection is greatly increased at the location of the base station Node B due to the structure of the access channel RACH and access messages used. In this context, the transmission of access messages can take place in a contention-based mode or contention-free mode, i.e. by using resources of the access channel RACH which are reserved exclusively for such a synchronization procedure or subscriber terminals with an already existing connection, or resources which are also used for other functionalities, for example for an initial access. This can be selected in dependence on the status of the subscriber terminal UE A and/or the currently supported service or predetermined by the standard specification or by system parameters signaled by the base station Node B.

As an alternative to a direct transition to resynchronization, the subscriber terminal UE A can also initially inform the base station Node B by signaling in the upward direction UL that the threshold value has been exceeded, as shown with a dashed border in FIG. 5. For this purpose, the subscriber terminal UE A can first attempt by autonomous adaptation of the time-based transmission of signals in the upward direction UL to compensate for the determined time offset. The signaling in the upward direction UL is subsequently evaluated by the base station Node B, if necessary compared with its own determinations (as described with reference to FIG. 4) and, in the case of agreement, it is decided that the subscriber terminal UE A should perform a new synchronization procedure. This is signaled to the subscriber terminal UE A in a next step so that it initiates, after evaluating the signaling, a new synchronization procedure described above. For the purpose of signaling, known signaling arrangements as are used for defining the step width and periodicity of binary commands can be used, changed or supplemented in such a manner, for example, that it is implicitly signaled to the subscriber terminal, at a certain value of the step width and/or the periodicity, to perform a new synchronization procedure.

As an alternative to or supplementing the method in FIG. 5, the subscriber terminal UE A, when it is found that the determined time offset is equal to or greater than the threshold value, can initially attempt in every case to perform an autonomous adaptation of the time-based transmission of signals in the upward direction UL with the aim of compensating for the determined time offset. If this is successful with signals sent in the upward direction UL to the base station Node B, the base station Node B continues with the signaling of binary or ternary timing control commands or, in the case of a greater offset, with a change to multi-step commands, but a procedure for resynchronization is not performed. After receiving timing control commands, the subscriber terminal UE A uses the autonomously compensated time offset as a new reference value and adapts the time-based transmission on the basis of this reference value for subsequent transmissions in accordance with the signaled commands. If, in contrast, the autonomous compensation should not be successful, the procedure continues with the method described above with reference to FIG. 5.

The steps, described with reference to FIG. 5, are especially advantageous for subscriber terminals or connections which do not require a fast response to greatly changing time offsets. These are subscriber terminals, for example, in a so-called RRC connected dormant mode or in an RRC connected mode with a service tolerant with respect to transmission delays such as, for example, downloading of a document.

The method described with respect to FIG. 4 and FIG. 5 can also be advantageously combined with one another, for example to the extent that a respective time offset is determined both in the base station Node B and in the subscriber terminal UE A and, in dependence thereon, an alignment is carried out with respect to the further exchange of timing control commands or the initiation of a new synchronization procedure between these. In particular, the threshold values mentioned above can be differently defined, for example in the sense that when a first threshold value is exceeded, a change from binary or ternary timing control commands to multi-step timing control commands is carried out and when a second, higher threshold value is exceeded, a new synchronization procedure is carried out.

In the case of a use of control commands, already mentioned above, it is made possible to be able to signal a required time-based control or change in the sense of “earlier”, “no change” and “later”, by ternary values, i.e. a signaling bit has, for example, three states (+1, 0, −1). Compared with the known binary signaling, this has the advantage, in particular, that only the states of “earlier” and “later” could be signaled by binary signaling even if no time-based change of the transmissions of the subscriber terminal UE A is actually required on the basis of the determined time offset (i.e the time offset is less than the predetermined maximum time offset), as can occur, for example, in the case of more or less stationary terminals, small radio cells or only a low speed of a perpendicular direction of movement of the terminal. It is only possible to signal earlier and later. In this case, the base station Node B would carry out a periodically changing signaling of “earlier” and “later” which would lead to a permanent adaptation, and, caused thereby, to a greater energy consumption in the subscriber terminal. By the third signalable state “no change” it is possible to signal to the subscriber terminal that it should not perform any adaptation of the time-based transmission of signals in the upward direction.

As an alternative to a use of a single signaling bit with three states, two signaling bits can also be defined for the same three timing control commands, for example with the three states 11 “earlier”, 00 “later” and 10 and/or 01 “no change”. Furthermore, the third state “no change” can also be implemented as an alternative by a suppression of the transmission of a timing control command in the sense of a discontinuous transmission DTX. This means that, when the subscriber terminal does not receive a command from the base station although it should actually receive one in accordance with the structure of the transmission of the command, it interprets this non-transmission as “no change” command.

The step width on which the timing control command is in each case based can be defined, for example, on a radio-cell basis or also subscriber-terminal-individually. If a dedicated channel is used in the upward direction UL, i.e. with an already existing connection, for controlling the time-based synchronization, a certain number of successive “no change” commands, for example, can signal to the subscriber terminal that the step width of the “earlier” or “later” commands is reduced or enlarged and/or that the periodicity of the time interval of the synchronization control is reduced, i.e. timing control commands are signaled less frequently. In contrast to the known method of binary signaling to the subscriber terminal, this advantageously does not require any dedicated, and thus requiring increased system load, signaling on higher layers. In addition, it is advantageously possible to omit an estimation of the speed of the subscriber terminal both by the subscriber terminal itself and by the base station which is required in the case of the known binary signaling.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-10. (canceled)

11. A method of controlling a time-based transmission of signals by a subscriber terminal for a synchronous reception at a base station of a radio communication system, comprising:
detecting whether a determined time offset of received signals is equal to or greater than a predetermined threshold value; and
if the determined time offset is equal to or greater than the predetermined threshold value, then (a) performing a change from one-step control commands to multi-step control commands to control the time-based transmission of signals by the subscriber terminal at the base station or (b) initiating a synchronization procedure through a randomly controlled access channel by the subscriber terminal.

12. The method as claimed in claim 11, wherein a binary or ternary signaling bit is used as one of the one-step control commands.

13. The method as claimed in claim 11, wherein the time offset is determined by the base station and/or the subscriber terminal.

14. The method as claimed in claim 11, wherein the time offset is determined by comparing a time of reception of received signals with a timing reference.

15. The method as claimed in claim 11, wherein a determination is made as to whether the change of the control commands is to be carried out or the synchronization procedure is to be initiated based on a current status of the subscriber terminal and/or a service type of an existing connection to the subscriber terminal.

16. The method as claimed in claim 12, wherein the time offset is determined by the base station and/or the subscriber terminal.

17. The method as claimed in claim 16, wherein the time offset is determined by comparing a time of reception of received signals with a timing reference.

18. The method as claimed in claim 17, wherein a determination is made as to whether the change of the control commands is to be carried out or the synchronization procedure is to be initiated based on a current status of the subscriber terminal and/or a service type of an existing connection to the subscriber terminal.

19. A method of controlling signals, comprising:
controlling a time-based transmission of signals of a subscriber terminal for a synchronous reception at a base station of a radio communication system, using ternary timing control commands at the base station.

20. A base station of a radio communication system, comprising:
at least one transmitting/receiving device receiving signals in an upward direction from at least one subscriber terminal and transmitting timing control commands to control a time-based transmission of subsequent signals of the at least one subscriber terminal; and
at least one controller determining a time offset from the received signals, comparing the determined time offset with a predetermined threshold value, and changing one-step control commands to multi-step control commands when the determined time offset is equal to or greater than the predetermined threshold value.

21. A subscriber terminal of a radio communication system, comprising:
at least one transmitting/receiving device transmitting signals in an upward direction to at least one base station of the radio communication system and receiving signals in a downward direction from the base station; and
at least one controller determining a time offset from the received signals, comparing the determined time offset with a predetermined threshold value, and initiating a synchronization procedure by a randomly controlled access channel when the determined time offset is equal to or greater than the predetermined threshold value.

22. The subscriber terminal as claimed in claim 21, wherein the at least one controller provides a time-based control of a subsequent transmission of signals to the base station, taking into consideration the determined time offset.

23. A radio communication system, comprising:
at least one subscriber terminal including at least one transmitting/receiving device transmitting signals in an upward direction and receiving signals in a downward direction and at least one controller determining a time offset from the received signals, comparing the determined time offset with a predetermined threshold value, and initiating a synchronization procedure by a randomly controlled access channel when the determined time offset is equal to or greater than the predetermined threshold value; and
at least one base station including at least one transmitting/receiving device receiving signals in the upward direction from the at least one subscriber terminal and transmitting timing control commands to the at least one subscriber terminal to control a time-based transmission of subsequent signals of the at least one subscriber terminal and at least one controller determining a time offset from the received signals, comparing the determined time offset with a predetermined threshold value, and changing one-step control commands to multi-step control commands when the determined time offset is equal to or greater than the predetermined threshold value.
